(19) United States
(12) Patent Application Publication
(10) Pub. No.: US 2023/0106264 A1
(43) Pub. Date: Apr. 6, 2023

(54) WASTEWATER TREATMENT SYSTEMS AND METHODS

(71) Applicant: WASE LTD, London (GB)

(72) Inventors: Thomas Philip Fudge, London (GB); William Sebastian Gore Gambier, London (GB); Isabella Maria Dorothy Bulmer, London (GB); Kyle Michael Bowman, London (GB); Llyr Anwyl, London (GB); Aeran Shawn Jenkinson, London (GB); George Edward Fudge, London (GB)

(73) Assignee: WASE LTD, London (GB)

(21) Appl. No.: 17/797,699

(22) PCT Filed: Feb. 8, 2021
(86) PCT No.: PCT/GB2021/050282

§ 371 Date: Aug. 4, 2022

(30) Foreign Application Priority Data
Feb. 7, 2020 (EP) 20156264.2

(51) Int. Cl. C02F 3/00; C02F 1/461; C02F 1/00; H01M 8/16

(52) U.S. Cl. CPC C02F 3/005; C02F 1/46109; C02F 1/008; H01M 8/16; C02F 2001/46133; C02F 2001/46152; C02F 2209/40; C02F 2209/008; C02F 2201/46165; C02F 2201/007; C02F 2201/46145

(57) ABSTRACT

An improved bio-electrochemical wastewater treatment process and system (1) is disclosed. An electrode assembly (4) is defined by interconnecting a set of electrode modules (5). Each electrode module (5) has a first electrode of an anode-cathode pair coated with electrogenic microbes adapted to generate electrons via the consumption of organic matter in wastewater. An electrode module (5) has a second electrode of the anode-cathode pair, and a body, supporting and separating the first and second electrodes. Each electrode module (5) also comprises an interface for physically connecting the module with at least one other of the set.

### FIELD OF THE INVENTION

The present invention relates to improvements to systems and methods for the treatment of wastewater or organic waste and generation of electricity and/or fuels. The present invention relates in particular to the application of biological electrochemical systems (BES), such as microbial fuel cells (MFCs) and microbial electrolysis cells (MECs) for use in such systems and methods.

### BACKGROUND TO THE INVENTION

Bioelectrochemical systems (BES) are increasingly finding application for the treatment of wastewater. These systems generally include electrodes coated with specific microorganisms that are able to purify wastewater, for example via the oxidation of organic compounds into carbon dioxide. Furthermore, these systems and processes are able to generate useful by-products including electricity, gaseous fuels such as methane and hydrogen, fertilisers, solid fuels such as biochar or charcoal, bioplastics and other valuable products.

The exact function and efficacy of a BES varies in dependence on the configuration of the system.

Generally, an anode is provided within an aqueous chamber into which wastewater to be purified is introduced. The anode is coated with exo-electrogenic bacteria which generate electrons, carbon dioxide, and protons (i.e. hydrogen ions) as organic matter is broken down. The electrons are conducted directly to the anode, whereas the protons remain within the aqueous solution.

If the BES is in a microbial fuel cell (MFC) configuration, for example, oxygen and the hydrogen ions are reduced at the cathode to generate water, with electricity being generated by the circuit between the anode and cathode. In an anaerobic MEC (microbial electrolysis cell) configuration, an external power source connected between the electrodes drives hydrogen production at the cathode instead, with increased levels of oxidation of organic matter at the anode. Additionally, electromethanogenic microorganisms on an electrode may be used to generate methane.

Such systems are becoming increasingly well-known for their application within public wastewater treatment plants, and the processing of waste in the chemical or food processing industries. These applications tend to be implemented via the connection of existing plant infrastructure to large-scale purpose-built bio-electrochemical systems that are designed for the specific needs of the plant. For example, input parameters such as the flow-rate of wastewater, its moisture content, organic loading rate, chemical oxygen demand (COD) etc. need to be optimally balanced against outputs such as treated water purity, biogas volume and electrical energy.

Accordingly, existing BES architectures tend to be bespoke to a particular wastewater treatment application, and are not adaptable enough to accommodate a wide range of different applications that have significantly varying input and output parameters. Accordingly, it is impractical to deploy many BES architectures at a smaller-scale, at remote locations, and/or for the purpose of retrofitting BES functionality to existing waste-handling infrastructure.

It is against this background that the present invention has been devised.

### SUMMARY OF THE INVENTION

According to a first aspect of the present invention there is provided a bio-electrochemical wastewater treatment system according to claim 1.

The system comprises at least one of a wastewater treatment tank, an electrode assembly, and an external electrical source or load. A circuit may also be provided to connect the external electrical source or load to the electrode assembly.

The tank ideally comprises a wastewater intake and a treated water outlet. In certain aspects the tank may be any suitable vessel or container for holding wastewater to be treated. For example, the tank could take the form of a bag, in an anaerobic bag digester. In certain aspects, the tank may extend to a reservoir or a specifically-constructed wetland, with wastewater flowing into it via an upstream source, and treated water flowing from it from a downstream source. It is preferred, however, for the tank to be a sealed vessel, with a specific wastewater intake, a treated water outlet, and ideally a gas port via which gases generated via the bio-electrochemical process can be harvested and utilised. Naturally, there may be multiple intakes, outlets, and gas posts. Additionally, the tank may be divided into a sequence of adjoining chambers thereby forcing wastewater to follow a non-linear path between the intake and the outlet, thereby advantageously increasing the period of treatment, and contact between the wastewater and the electrode assembly.

Preferably, in use, the electrode assembly is submerged within the wastewater treatment tank between the intake and outlet. Preferably, the electrode assembly comprises a set of electrode modules. These may be interconnectable with one another. One or more of the set of electrode modules ideally comprise a first and second electrode of an anode-cathode pair. The first electrode, ideally the anode of the anode-cathode pair, may be provided with a bio-coating of electrogenic microbes adapted to generate electrons via the consumption of organic matter in wastewater. The coating may comprise electromethanogenic microbes, thereby capable of generating both electricity and methane via the consumption of organic matter within the wastewater. The coating may comprise hydrogenotropic microbes capable of generating biogas via the conversion of organic matter, hydrogen and/or carbon dioxide. A heterogeneous set of microbes may be used in each coating. Examples of microbes for this purpose include bacteria of the genera Geobacter and Shewanella.

In some aspects, the second electrode—ideally the cathode of the anode-cathode pair—may not necessarily be coated with microbes. In other aspects, at least some of the second electrodes may also be provided with similar coatings.

Ideally, a body of the electrode modules supports the first and second electrodes, and separates them both physically and electrically.

To facilitate modularity, the electrode modules comprise an interface via which they may be connected to one another. Moreover, the interface may be configured and arranged to physically connect an electrode module with at least one other. Preferably, the interface is configured and arranged to physically connect an electrode module with at least two others thereby allowing a chain of electrode modules to be defined. Additionally, the interface is further arranged to electrically-connect the electrodes of interconnected electrode modules. In particular, the interface facilitates connection between the first and second electrodes of one electrode module with respective first and second electrodes of other connected electrode modules. Thus, in a set of electrode modules, all of the first electrodes are electrically-connected together, and independent to this, all of the second electrodes are electrically-connected together.

Preferably, the system also comprises a circuit that electrically-connects the electrodes of the set of electrode modules to an electrical source or load. The system may be configured to control switching between an electrical source or load depending on the configuration of the thus defined bio-electrochemical system. Typically, if the system is to operate in a microbial fuel cell (MFC) configuration, for example, the circuit electrically-connects the electrodes of the set of electrode modules to an electrical load. If the system is to operate in a microbial electrolysis cell (MEC) configuration, for example, the circuit electrically-connects the electrodes of the set of electrode modules to an electrical source. An electrical source may comprise a solar panel. An electrical load may comprise another system according to an aspect of the present invention. Thus circuits of different systems may be coupled to one another, for example with an MFC providing electrical power to an MEC.

The modularly of the resulting system is particular advantageous, and overcomes the drawbacks of existing system described in the preamble, at least in part. For example, as the electrode assembly can be composed of a set of electrode modules, its size, shape and capabilities can be adapted for a variety of different profiles of wastewater treatment tank. The rate of reduction of

BOD, generation of biogas and/or electricity can be modified by connecting together a greater or fewer number of modules as appropriate.

It should be noted that the electrode modules are preferred to be membraneless—for example, without a proton exchange membrane between them.

Preferably, at least one of the first and second electrode—ideally the anode—is a brush electrode.

At least one of the first and second electrode—ideally the cathode—is a pocket electrode. The electrode module may comprise a set of electrode holders. Each holder may comprise complementary interfaces to allow connection between at least two holders. The complementary interfaces may comprise at least one of a sliding interface and a snap-fit interface.

Preferably, each electrode is elongate, so as to define a longitudinal axis. Preferably, the first and second electrodes are held by the body so that their respective longitudinal axes are substantially parallel to one another.

Preferably, each electrode module further comprises a plurality of holders that define at least in part, the body for supporting and separating the electrodes.

At least a pair of the holders may be spaced from and secured relative to one another by at least one elongate strut to define an elongate framework within which each electrode is held so that a longitudinal axis of the elongate framework, and the longitudinal axes of the electrodes are substantially parallel to one another.

Preferably, each holder defines a plurality of spaced connection regions, each for detachably holding a respective electrode. The connection regions of each holder may comprise a plurality of slots within which an attachment portion of a respective electrode can be encapsulated to prevent relative movement of the electrodes.

Preferably, the attachment portion of an electrode is slidable into or out from a respective slot during fitment or removal of that electrode. Preferably, the attachment portion of an electrode is electrically-conductive.

At least one of the plurality of holders comprises a pair of conductor tracks. Each conductor track may be arranged to retain a conductor for electrical connection to a respective electrode.

Specifically, a first track may run via the first electrode, and a second track may run via the second electrode.

At least one of the holders may comprise clamping portions that have a clamping configuration in which the clamping portions are compressed towards one another to trap the electrodes in place. The clamping portions, in their clamping configuration, may compress a first and second conductor against respective first and second electrodes. The conductors may span across multiple electrode modules.

The holders and conductors in combination may define, at least in part, the interface for physically and electrically connecting the electrode module with at least one other of the set. The electrode assembly may comprise a junction box. The interface may comprise the junction box.

The electrode assembly may comprise a shell for isolating the electrode assembly from others. The electrode assembly may comprise resilient rods. The rods may be wound around the electrode modules of the electrode assembly. The shell is ideally therefore a predominantly open structure, thereby allowing waste to flow freely past and throughout the electrodes.

As mentioned, the system of aspects of the present invention may be applied to an anaerobic bag digester, and thus be used for enhancing their operation, in particular for the generation of biogas. The electrode assembly mentioned above in particular, can be incorporated into an anaerobic digestor, and a multitude of other waste processing reactors to enhance their operation.

Preferably, the interface of one electrode module comprises a coupling member for coupling with a complementary coupling member of another electrode module. One coupling member may be a plug and the other may be a socket for example. Ideally, the interface of each electrode module of the set comprises a coupling member, such as a plug or socket, for coupling with a complementary coupling member, such as a socket or plug of other electrode modules of the set.

Ideally, complementary coupling members are shaped and arranged for a push-fit or snap-fit connection. The interface may comprise a latch portion for preventing uncoupling of connected complementary coupling members.

The body of each electrode module may be elongate, thus defining a first end and a second end. Ideally, the interface of each electrode module comprises first and second complementary coupling members located toward respective first and second ends of the body. Advantageously, this allows an elongate series of electrode modules to be connected to one another.

Preferably, the system comprises a buoy. Preferably, the buoy is arranged, in use to float within the wastewater treatment tank. Ideally, the buoy comprises a connector configured and arranged for connection with the interface of an electrode module. Thus, in use, a set of electrode modules can hang from the buoy, submerged in the wastewater to be treated. In certain aspects, the connector of the buoy is further coupled to the circuit leading to the electrical source or load. Advantageously, this allows easy assembly of the system as only a single connection is required.

Preferably, the system comprises a weight. Ideally, the weight comprises a connector configured and arranged for connection with the interface of an electrode module. When both a buoy and weight are used together, this draws a set of interconnected electrode modules between them—with a buoy at their upper end and a weight at their lower end—into a vertical position between the buoy and the weight.

Advantageously, the buoy/weight arrangement ensures that the electrodes are kept submerged within the wastewater treatment tank. This is important when the tank contains a gaseous headspace. If the microbes coated on the electrodes enter the headspace they cannot consume organic matter within the wastewater, and so will not effectively treat the wastewater. Moreover, the microbial population cannot thrive without an organic food source, and so will dwindle over time.

Preferably, the electrode assembly comprises at least two sets of interconnectable electrode modules. Furthermore, the buoy may comprise at least two corresponding connectors for connection with a respective set of electrode modules. The at least two connectors may be positioned and spaced from one another to separate each set of electrode modules from one another in use. The system may comprise separation struts for this purpose, or the at least two connectors may simply be positioned on the buoy at different spaced locations.

It should be noted that the buoy may be made from one or more buoy members. For example, the buoy could be a matrix of buoy members (e.g., ball floats) interconnected and separated from one another by separation struts. Alternatively, the buoy may be constructed from a single unit containing low-density material. The buoy could comprise one or more inflatable bladders, for example.

Advantageously, when the buoy is inflatable, even at least in part, this allows the buoy to occupy a smaller volume during transport than when in use within the wastewater treatment tank.

The system may similarly be provided with one or more weights. When there are a plurality of weights, there is ideally one for each set of electrode modules. In certain aspects, the plurality of weights may be interconnected and separated from one another by struts. It is preferred that this matches the separation at the upper end of the electrode sets so that each electrode set is suspended between the weight(s) and buoy(s) in orientations that are ideally both vertical and parallel to one another. This allows an optimal distribution of wastewater treatment sites throughout the tank, and also prevent short-circuiting of the electrodes.

As mentioned, in certain aspects of the invention, the tank may take on other forms, and may not necessarily be sealed for the benefits of the invention to be realised. The wastewater treatment tank may be open at its upper end for example. In this example, it is preferred that the system further comprises a gas trap configured and arranged to capture gas emitted by the electrode assembly, and in particular from the electrodes of the anode-cathode pairs defined by the one or more sets of electrode modules. The gas trap is ideally configured for attachment relative to the electrode assembly above the electrode modules so as to capture gas such as methane and/or hydrogen. Advantageously, the allows flexibility in the choice of wastewater tank—it need not necessarily be sealed or provided with a gas port.

Particularly envisaged is the deployment of certain aspects of the system in an outdoor environment such as within a wetland environment. In such aspects, the gas trap and/or buoy(s) typically float on the surface of the wastewater to be treated. Furthermore, they may support other components of the system, such as external electrical sources or loads. For example, solar panels can be supported and connected to the electrode modules. A further advantage resides in contacting or circulating water across a rear surface of the solar panels. This has the advantage of cooling them down, thereby increasing their performance. This also typically raises the temperature at the reaction sites adjacent to the electrodes of the system again improving reaction efficacy and so the efficiency of the breakdown of organic matter within the wastewater.

The body of each electrode module is ideally constructed from a material that is flexible. Advantageously, this allows the electrode modules to be rolled up for easy transport to remote locations. The material is ideally porous, allowing flow-through of wastewater.

Preferably, the electrode assembly comprises a plurality of electrode modules disposed between the intake and the outlet with a varying spacing between the anode-cathode pairs defined by the electrode modules. The spacing may vary depending on the position of the anode-cathode pairs between the intake and outlet. For example, the spacing between the anode-cathode pairs defined by the electrode modules is ideally wider nearer to the intake, and narrower closest to the outlet. Advantageously, as the intake contains a higher density of organic material, there is a greater chance of clogging. Thus having a wider spacing near the intake offsets this risk. As the wastewater passes through the tank towards the outlet, organic material density decreases. Thus, to proportionally increase the efficacy of treatment, it is advantageous to decrease the spacing between the anode-cathode pairs defined by the electrode modules. Ultimately, it is beneficial for the spacing to be widest closest to the intake, and narrowest closest to the outlet.

To allow easy retrofitting of the electrode assembly to containers such as anaerobic bag digesters, aspects of the invention may allow for the electrode assembly to be switchable between a unexpanded configuration and an expanded configuration. In an unexpanded configuration, the electrode assembly occupies a small volume and so can be easily inserted into such containers. The electrode assembly can then be switched to the expanded configuration to increase its volume thereby to maximise the efficacy of the electrodes.

In certain aspects the electrode assembly comprises a support that is inflatable, at least in part, so that when inflated, the electrode assembly is in the expanded configuration, and when deflated, the electrode assembly is in the unexpanded configuration. For example, the support may comprise a gas tube with spurring branches on which electrodes are supported. When a gas is forced into the gas tube, the electrode assembly is able to switch to the expanded configuration where the branches separate and fan out. The electrode assembly may also comprise sufficiently weighted portions so that it remains submerged within the wastewater to be treated despite the introduction of air into the gas tube.

In a second specific aspect of the invention there is provided an electrode assembly for use with a wastewater treatment system. Preferably, the electrode assembly is adapted for submersion within a wastewater treatment tank, and comprises a set of interconnectable electrode modules as described above in relation to the first aspect. Specifically, each electrode module comprises at least one of:

a first electrode of an anode-cathode pair coated with electrogenic microbes adapted to generate electrons via the consumption of organic matter in wastewater;

a second electrode of the anode-cathode pair;

a body, ideally supporting and separating the first and second electrodes; and an interface for physically connecting the module with at least one other of the set.

Naturally, the interface may be further arranged to electrically-connect the first and second electrodes of the electrode module with respective first and second electrodes of other connected electrode modules of the set.

In a third specific aspect of the present invention there is provided a bio-electrochemical wastewater treatment process comprising at least one of:

providing an electrode assembly, for example by interconnecting a set of electrode modules;

submerging the electrode assembly within a wastewater treatment tank, the tank comprising a wastewater intake and a treated water outlet, and the electrode assembly being disposed between the intake and the outlet;

and electrically-connecting the electrodes of the set of electrode modules, via a circuit to an external electrical source or load.

Ideally, the or each electrode module comprises at least one of:

a first electrode of an anode-cathode pair coated with electrogenic microbes adapted to generate electrons via the consumption of organic matter in wastewater;

a second electrode of the anode-cathode pair;

a body, ideally supporting and separating the first and second electrodes; and an interface for physically connecting the module with at least one other of the set. The interface may be further arranged to electrically-connect the first and second electrodes of the electrode module with respective first and second electrodes of other connected electrode modules of the set;

It will be understood that features and advantages of different aspects of the present invention may be combined or substituted with one another where context allows. For example, the features of the system described in relation to the first aspect of the present invention may be present on the electrode assembly described in relation to the second aspect of the present invention. Furthermore, such features may themselves constitute further aspects of the present invention. For example, the electrode modules of the electrode assembly of the system according to the first aspect may itself constitute a further aspect of the present invention.

### BRIEF DESCRIPTION OF THE DRAWINGS

In order for the invention to be more readily understood, embodiments of the invention will now be described, by way of example only, with reference to the accompanying drawings in which:

FIG. 1 is a schematic plan diagram of a wastewater treatment system according to a first embodiment of the present invention;

FIG. 2 is an overhead schematic view of the system of FIG. 1;

FIG. 3 is a schematic plan diagram of a wastewater treatment system according to a second embodiment of the present invention;

FIG. 4 is an overhead schematic view of a first variant of the system of FIG. 3;

FIG. 5 is an overhead schematic view of a second variant of the system of FIG. 3;

FIG. 6 is a schematic plan diagram of a wastewater treatment system according to a third embodiment of the present invention;

FIG. 7 is a schematic view of an electrode module for use in any one of the wastewater treatment system of FIGS. 1 to 6;

FIG. 8 is a schematic view of a buoy for use in the wastewater treatment system of FIGS. 1 and 2;

FIG. 9 is a schematic view of a weight for use in the wastewater treatment system of any one of FIGS. 1 to 6;

FIG. 10 is a schematic plan diagram of a wastewater treatment system according to a fourth embodiment of the present invention;

FIGS. 11 and 12 are schematic views of an electrode module substitutive with that shown in FIG. 7;

FIG. 13 is a schematic plan diagram of a wastewater treatment system according to a fifth embodiment of the present invention;

FIG. 14 is a perspective view of an electrode assembly, according to a further exemplary embodiment of the present invention, having a set of two identical interconnected electrode modules;

FIG. 15 is a perspective view of the electrode assembly of FIG. 14, with those two electrode modules shown in isolation and separated from one another;

FIG. 16 is a partial perspective view of an upper end of the two electrode modules of FIG. 14 interconnected with one another;

FIG. 17 is a perspective view of a frame of one of the electrode modules of FIG. 14, as defined by holders and struts in isolation;

FIG. 18 is a perspective exploded view of one of the electrode module of FIG. 14;

FIG. 19 is an overhead view of an electrode module of FIG. 14;

FIGS. 20, 21 and 22 are partial perspective views of the upper end of the electrode module of

FIG. 19, showing the progression of physical and electrical connection of the electrodes;

FIG. 23 is a partial side view of the arrangement of components of the electrode module shown in FIG. 21;

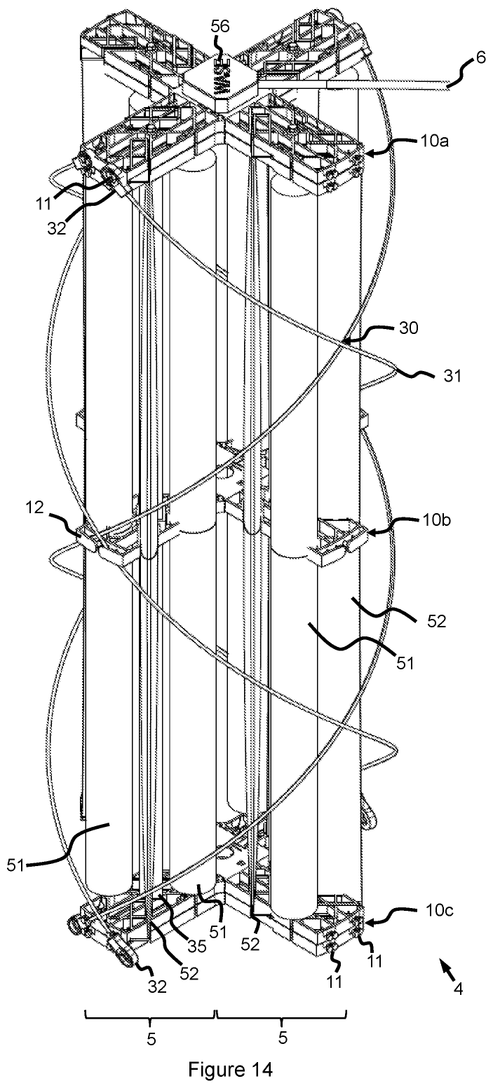

FIG. 24 is a perspective overhead view of a member of a holder of the electrode module of FIG. 14;

FIG. 25 is perspective underside view of the member of FIG. 24; and

FIG. 26 is a schematic plan diagram of a wastewater treatment system, the components of which are extensions to various embodiments of the present invention.

### SPECIFIC DESCRIPTION

FIG. 1 is a schematic plan diagram of a wastewater treatment system 1 according to a first embodiment of the present invention. The system 1 comprises a wastewater treatment tank 2 within which wastewater or organic waste 3 is contained for treatment. The system 1 also comprises an electrode assembly 4 having a plurality of electrode modules 5, a circuit 6 and an external electrical device 7 which may be an electrical source or load depending on the configuration of system 1. The circuit 6 connects the external electrical device 7 to the electrode assembly 4.

The system 1 further comprises a buoy 8 which floats on the surface of the wastewater 3 and which supports the electrode assembly 4. Within the tank 2 above the surface of the wastewater 3 is a gaseous headspace 23. The tank 2 comprises an intake 20 via which wastewater 3 is passed into the tank 2, an outlet 21 via which treated water is removed from the tank 2, and also a gas port 22 which communicates with the headspace 23.

In alternative embodiments, the tank may be substituted with any suitable vessel or container for holding wastewater to be treated, and take on different sizes, shapes and forms. For example, the tank in FIG. 1 may be substituted with a bag of an anaerobic bag digester 2c as shown in FIG. 13. In certain embodiments, the “tank” may extend to a reservoir or a specifically-constructed wetland, with wastewater flowing into it via an upstream source, and treated water flowing from it from a downstream source, the “tank” being unsealed and open at its upper end at least in part.

The tank 1 of the embodiment of FIG. 1 however is sealed so that gases generated via the bio-electrochemical process can be extracted from the headspace 23 via the gas port 22 and so harvested and utilised.

In alternatives, there may be multiple intakes, outlets, and gas posts. Additionally, the tank may be divided into a sequence of adjoining chambers thereby forcing wastewater to follow a non-linear path between the intake and the outlet, thereby advantageously increasing the period of treatment, and contact between the wastewater and the electrode assembly.

The electrode assembly 4 is submerged within the wastewater 3 of the wastewater treatment tank 2 between the intake 20 and outlet 21. The electrode assembly 4 has seven sets of electrode modules 5, only four of which are shown schematically in FIG. 1. Each electrode module 5 is identical, and interconnected to adjacent others in the same set. Whilst there are advantages associated with mass-production of identical electrode modules 5, it will be understood that, in alternative embodiments, the electrode modules need not be identical.

FIG. 7 is a schematic view of one of these electrode module 5. Each electrode module 5 comprises of electrodes, including a first electrode 51 functioning as an anode 51 of an anode-cathode pair, and second electrode 52 functioning as a cathode 52 of the anode-cathode pair. The anode 51 is provided with a bio-coating of electrogenic microbes adapted to generate electrons via the consumption of organic matter in wastewater. The coating comprises heterogeneous cultures of electromethanogenic microbes, capable of generating both electricity and methane via the consumption of organic matter within the wastewater. The cathode of the anode-cathode pair is not coated with microbes in this embodiment, but may be in alternatives. Each electrode module 5 also comprises a flexible, porous and elongate body 50 that supports the first and second electrodes, and separates them both physically and electrically with anodes disposed on one flat side of the body, and cathodes disposed on the reverse flat side of the body 50.

FIGS. 11 and 12 are schematic views of an electrode module substitutive with that shown in FIG. 7. As can be seen, flexible body 50 allows rolling of the electrode modules 5 permitting easy transport and flexibility in configuration. This also allows for the easy insertion to retrofit electrodes into various tanks through small ports within the tanks 2. FIGS. 11a, 11b, 11c and 11d show alternative shapes that the electrode module(s) can take so as to conform to a particularly-shaped tank 2.

Referring back to FIG. 7, each electrode module 5 also comprises an interface 53 via which it can be connected to two other electrode modules 5. The elongate body 50 of the electrode module 5 defines first and second ends of the body 50 at each of which part of the interface 53 is provided. Specifically, the interface 53 comprises a plug 54 positioned towards the first upper end of the electrode module 5, and a socket 55 positioned towards the second lower end of the electrode module 5. The plug 54 and socket 55 are complementary, allowing a push-fit connection to be made between adjacent electrode modules 5 within a set, the push-fit connection allowing adjacent electrode modules 5 to be electrically and physically connected to one another. In alternatives, other quick release fittings or fastenings may be used to create a connection. To prevent unintentional disconnection, a latch portion is also provided as part of the plug-and-socket arrangement. The fastening methods allows the electrode modules to distribute and adapt to the shape of different vessels.

In alternative embodiments, the interface may comprise other complementary coupling members instead of the plug 54 and socket 55. Nonetheless, the interface serves to electrically-connect corresponding electrodes 51, 52 of interconnected electrode modules 5. Thus, in each set of electrode modules 5, all of the first electrodes 51 (anodes) are electrically-connected together, and independent to this, all of the second electrodes 52 (cathodes) are electrically-connected together.

Referring back to FIG. 1, each set of electrode modules 5 is suspended between a ball float 81, which acts as a buoy member of the buoy 8, and a weight 9. To this end, each ball float 81 and weight 9 have connectors to which a chain of electrode modules 5 of a set can be linked:

FIG. 8 is a schematic view of the ball float 81, and FIG. 9 is a schematic view of the weight 9, each in isolation. The ball float 81 comprises a connector 85, similar to the socket 55 of an electrode module 5 in that it is complementary and connectable with the plug 54 of an electrode module 5. Moreover, the connector 85 further electrically couples to the circuit 6 leading to the electrical source or load 7. Advantageously, this allows easy assembly of the system as only a single connection is required. The weight 9 also comprises a connector 94 that is similar to the plug 54 of an electrode module 5 in that it is complementary and connectable with the socket 55 of an electrode module 5.

Referring back to FIG. 1, each ball float 81 and buoy 8 in general floats on the surface of the wastewater 3 within the tank 2, with each set of electrode modules hanging from the buoy 8, submerged in the wastewater to be treated with the weights 9 drawing each set of interconnected electrode modules 5 into a vertical position between the buoy 8 and the weights 9.

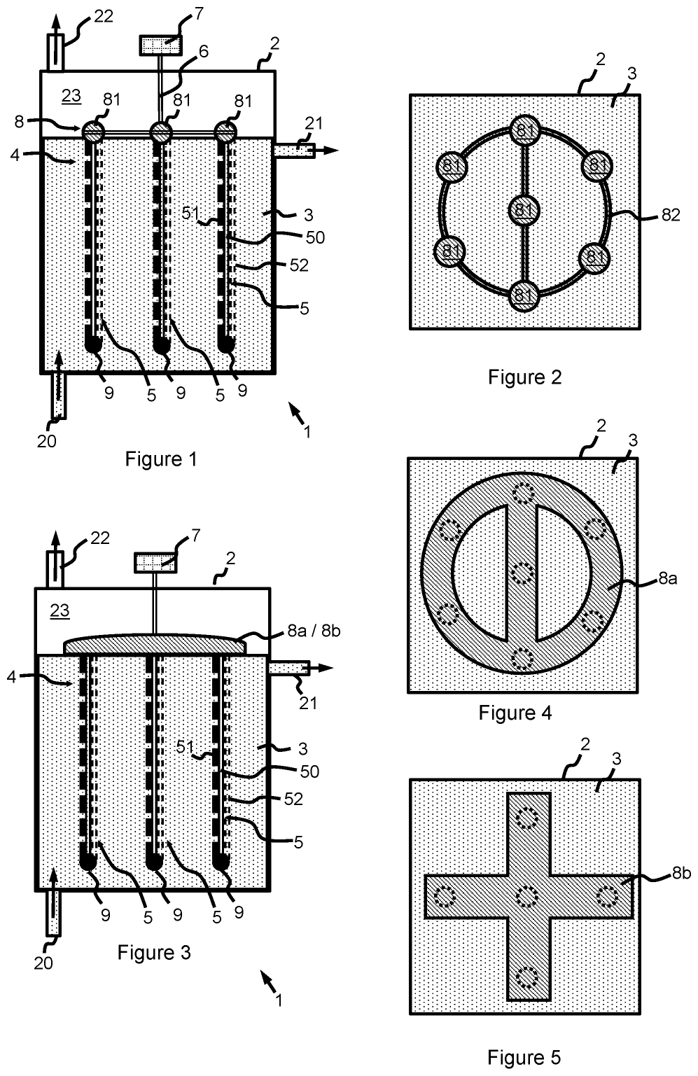

Referring to FIG. 2 which is an overhead schematic view of the inside of the tank 2 shown in FIG. 1, a matrix of seven ball floats 81 are held equally-spaced from one another by separation struts 82 which also allow for the electrical connection of each set of electrode modules 5 to the circuit 6. The equal spacing prevents short-circuits and also promotes an optimal distribution of electrode module sets and thus wastewater treatment sites throughout the tank 2.

In alternative embodiments, a different arrangement of components are possible:

FIG. 3 is a schematic plan diagram of a wastewater treatment system 1 according to a second embodiment of the present invention. Like components are denoted by the same reference numerals. In this second embodiment, the buoy 8 is not composed from individual buoy members 81 but instead is constructed from a single unit in the form of an inflatable bladder. A side view of the inflatable bladder buoy 8 is shown schematically in FIG. 3, but it will be understood that many variants and shapes of such a buoy 8 are possible. FIGS. 4 and 5 are overhead schematic views of the system of FIG. 3 incorporating buoys 8a, 8b of two example variants. In each case, separation struts are not required but can be used, and the connectors 85 for hanging respective sets of electrode modules 5 are simply disposed on the underside of the body of these buoy 8a, 8b at different spaced locations as denoted by the circles in dashed outline in FIGS. 4 and 5.

In further alternatives, the buoy may be constructed from a low-density material. However, an advantage of the inflatable bladder variants is that that these can be deflated to occupy a small volume for transport, and then inflated on site for use. Similarly, individual ball floats of the first embodiment may be inflatable. Also in alternative embodiments, the weights may have alternative arrangements. For example, a plurality of weights 9, one for each set of electrode modules, may be free-hanging as in FIGS. 1 and 3, or may be interconnected and separated from one another by struts. In the latter case, it is preferred that this matches the separation at the upper end of the electrode sets so that each electrode set is suspended between the weight(s) and buoy(s) in orientations that are ideally both vertical and parallel to one another. As discussed, this allows an optimal equal distribution of wastewater treatment sites throughout the tank, and also prevent short-circuiting of the electrodes.

However, in some situations it can be advantageous to choose an unequal distribution of electrode modules. FIGS. 1 and 3 show up-flow tanks in which the intake 20 is situated at a lower part of the tank, the outlet 21 is near the top, and so fluid flow is generally vertical. As mentioned, other tank designs are possible and compatible with the invention and alternative electrode module distributions may be more appropriate.

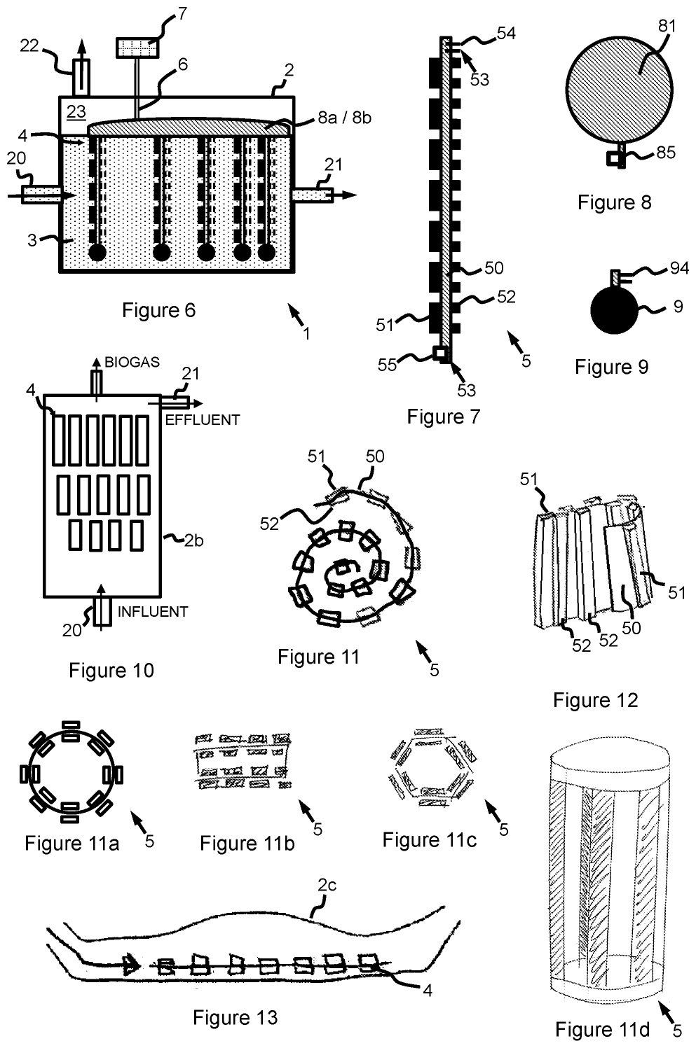

FIG. 6, for example, is schematic plan diagram of a wastewater treatment system according to a third embodiment of the present invention. It shows a side-flow tank 2a where wastewater fluid flow is substantially lateral. In further alternatives, the tank may be compartmentalised with wastewater fluid flow being forced along a non-linear (typically up-and-down) path.

In FIG. 6, the electrode module sets are intentionally unevenly distributed with the electrode modules 5 disposed at irregular intervals, the spacing between them being wider nearer to the intake, and narrower closest to the outlet. Advantageously, as the intake contains a higher density of organic material, there is a greater chance of clogging. Thus having a wider spacing near the intake offsets this risk. As the wastewater passes through the tank towards the outlet, organic material density decreases. Thus, to proportionally increase the efficacy of treatment, it is advantageous to decrease the spacing between the anode-cathode pairs defined by the electrode modules. Ultimately, it is beneficial for the spacing to be widest closest to the intake 20, and narrowest closest to the outlet 21.

Referring to FIG. 10 a similar advantage can be realised with an up-flow reactor. FIG. 10 is a schematic plan diagram of a wastewater treatment system according to a fourth embodiment of the present invention, and in this case, the electrode density increases from bottom to top—towards the outlet (effluent port).

Further embodiments may substitute the buoy and/or the weights with a frame or support that is insertable into the tank 2, the frame holding and maintaining the electrode modules 5 within a specific arrangement and at a specific location within the tank 2.

Further embodiments may comprise tanks that are open at their upper end. In such alternatives, it is preferred that the system further comprises a gas trap configured and arranged to capture gas emitted by the electrode assembly, and in particular from the electrodes of the anode-cathode pairs defined by the one or more sets of electrode modules. The gas trap is ideally configured for attachment relative to the electrode assembly above the electrode modules so as to capture gas such as methane and/or hydrogen. Advantageously, the allows flexibility in the choice of wastewater tank—it need not necessarily be sealed or provided with a gas port 22.

Particularly envisaged is the deployment of certain aspects of the system in an outdoor environment such as within a wetland environment. In such aspects, the gas trap and/or buoy(s) typically float on the surface of the wastewater to be treated. Furthermore, they may support other components of the system, such as external electrical sources or loads 7. For example, solar panels can be supported and connected to the electrode modules. A further advantage resides in contacting or circulating water across a rear surface of the solar panels. This has the advantage of cooling them down, thereby increasing their performance. This also typically raises the temperature at the reaction sites adjacent to the electrodes of the system again improving reaction efficacy and so the efficiency of the breakdown of organic matter within the wastewater.

To allow easy retrofitting of the electrode assembly to containers such as anaerobic bag digesters such as that shown in FIG. 13, aspects of the invention may allow for the electrode assembly to be switchable between an unexpanded configuration and an expanded configuration. In an unexpanded configuration, the electrode assembly occupies a small volume and so can be easily inserted into such containers. The electrode assembly can then be switched to the expanded configuration to increase its volume thereby to maximise the efficacy of the electrodes.

In certain aspects the electrode assembly comprises a support that is inflatable, at least in part, so that when inflated, the electrode assembly is in the expanded configuration, and when deflated, the electrode assembly is in the unexpanded configuration. For example, the support may comprise a gas tube with spurring branches on which electrodes are supported. When a gas is forced into the gas tube, the electrode assembly is able to switch to the expanded configuration where the branches separate and fan out. The electrode assembly may also comprise sufficiently weighted portions so that it remains submerged within the wastewater to be treated despite the introduction of air into the gas tube.

In other embodiments, the expanded configuration may be defined by electrodes modules that can be connected together with a fixed support that conforms to a particular size and shape vessel—thereby expanding the surface area of the operative electrodes.

In each embodiment described, the circuit 6 electrically-connects the electrodes 5 of each set of electrode modules to an electrical source or load 7. The system 1 can be configured to control switching between an electrical source or load depending on the configuration of the thus defined bio-electrochemical system. An electrical load may comprise another system according to an aspect of the present invention. Thus circuits of different systems may be coupled to one another, for example with the system 1 configured as an MFC providing electrical power to a system configured as an MEC.

The modularly of the resulting system 1 is particular advantageous, and overcomes the drawbacks of existing BESs described in the preamble, at least in part. For example, as the electrode assembly 4 can be composed of different combinations of electrode modules 5, its size, shape and capabilities can be adapted for a variety of different profiles of wastewater treatment tank. Furthermore, embodiments of the system 1 may be applied to an anaerobic bag digester, and thus be used for enhancing their operation, in particular for the generation of biogas.

FIG. 14 is a perspective view of an electrode assembly 4, according to a further embodiment of the present invention, having a set of two identical interconnected electrode modules 5. These can be substituted with electrode modules described above in the various systems that exemplify the invention.

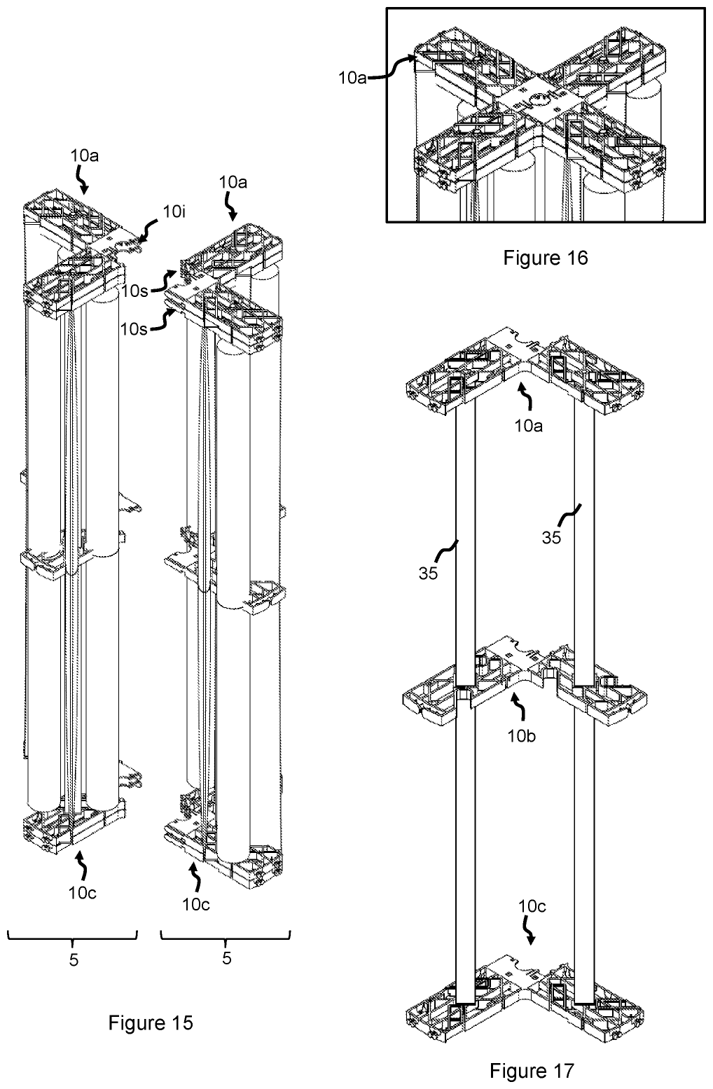

FIG. 15 is a perspective view of the electrode assembly of FIG. 14, with those two electrode modules 5 shown in isolation and separated from one another. Each electrode module 5 has eight distinct electrodes—defined by four brush anodes 51, and four pocket cathodes 52. It should be noted that in alternative embodiments, the electrodes referred to as anodes may be used as cathodes instead, and vice-versa.

The electrodes 51, 52 are elongate in shape, each generally defining a longitudinal axis. The electrodes 51, 52 are connected to a set of broadly L-shaped electrode holders 10 which slide into locking engagement with another, as illustrated in the partial perspective view of FIG. 16. In particular, each holder 10 has complementary sliding interfaces 10s and snap-fit interface 10i that cooperate to allow each holder 10, and so each electrode module 5 as a whole to slide and lock to one another. The holders 10 of each electrode module 5 join back-to-back to combine into a broadly cross-shaped structure. Thus, the electrode assembly 4 as a whole, composed of two interlocked electrode modules 5, has a cluster of sixteen electrodes in total.

Each electrode module 5 comprises a set of elongate box section struts 35 that join together with the electrode holders 10 to define a frame for holding and maintaining the position and arrangement of the electrodes 51, 52. FIG. 17 shows the frame of an electrode module 5, as defined by some of the holders 10 and struts 35.

Referring back to FIG. 14, the electrodes 51, 52 are secured so that their respective longitudinal axes are held parallel to one another, spanning from a first upper holder 10a, via a second middle holder 10b, to a third lower holder 10c. The elongate struts 35 also span between the holders 10a, 10b, 10c in the same way, are aligned with the electrodes, and increase the rigidity of the frame, restraining against pivotal movement that may otherwise be present at the locations where the holders 10 are connected to the electrodes.

Accordingly, the struts 35 and the holders 10 in particular function in a manner similar to a body 50 of an electrode (e.g., FIG. 7 as described above) in that they support and separate the electrodes 51, 52 from one another. However, whereas the previously-described body 50 is flexible, the struts 35 and holders 10 are rigid. Nonetheless, the electrode modules 50 can be easily assembled and disassembled, and can be expanded in a modular way to allow the electrode assembly 4 to be adaptable for use across a wide range of application, including relatively small-scale BES suitable for remote installations, or convenient retrofits to existing waste-handling infrastructures.

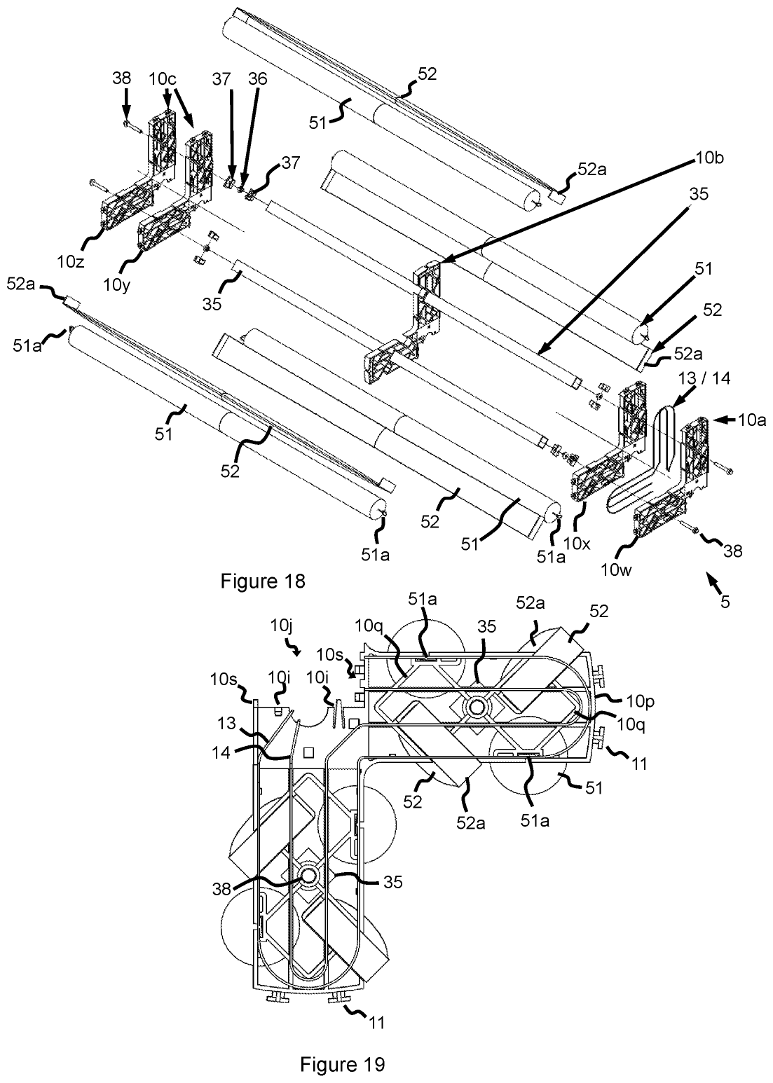

FIG. 18 is a perspective exploded view of one of the electrode modules 5, showing how various components of the electrode module 5 can be assembled to one another. As shown, the electrode module 5 further comprises a set of flanged nuts 36, end caps 37, flanged bolts 38 and titanium anodic and cathodic conductors 13, 14.

The upper holder 10a, and the lower holder 10c are each of a two-piece construction, with a respective inner member 10x, 10y adjacent to the electrode 51, 52, and a respective outer member 10w, 10z at the outer ends of the electrode module 5. The holder members 10w-10z, and the middle holder 10b are each made from an integral piece of injection-moulded plastics material. Each defines a broadly L-shaped peripheral wall 10p reinforced internally by a criss-cross arrangement of webs 10q, with the wall 10p and webs 10q extending along vertical planes—thereby simplifying removal from a mould during manufacture. The inner and outer members 10w-10z can be made from a common mould, reducing manufacturing cost and complexity.

The inner and outer members 10w-10z define a pair of central bolt holes through which the threaded part of a corresponding flanged bolt 38 can be passed through to the nut 36 of the strut 35. Each box section strut 35 has securely fixed (e.g., welded) within each of its otherwise hollow ends an end cap 37 that encapsulates a flanged nut 36. Accordingly, screwing in the bolt 38 allows each pair of inner and outer members to be clamped together, and tightly affixed to a respective strut 35. The upper holder 10a further clamps the conductors 13, 14 into place such that the anodes 51 are electrically connected to one another via the first anodic conductor 13, and the cathodes 52 are electrically connected to one another via the second cathodic conductor 14.

Each anodic electrode 51 is a brush electrode, having a twisted wire core leading to and terminating at each end in a wire loop 51a. Conductive brush filaments trapped by the wire core extend radially outward from the core at a regular length, such that the electrode 51 forms a broadly cylindrical brush along almost all of its longitudinal length. The filaments of the brush anodes 51 are bio-coated (as before) with electrogenic microbes for consumption of organic matter within the waste water 3. Brushes provide a convenient way to maximise the surface area to volume ratio of the anodes 51—allowing relatively high rates of organic waste consumption.

Each cathodic electrode 52 is a pocket electrode that is of a hollow marine-grade stainless steel construction the shape of which approximates to a flattened tube with crimped ends 52a. The pockets are filled with granulated activated carbon (GAC) which is conductive and again represents a way of increasing the surface area of the electrode and, over time, encourages the growth of microbes assistive of waste breakdown. The walls of the pocket electrode are meshed or perforated such that waste water can enter the pocket, but the GAC is retained within during operation.

The crimped ends 52a of the cathode 52, and the loops 51a of the anode are attachment portions of the electrodes. They are electrically-conductive and serve as physical and electrical attachment junctions, allowing the electrodes to be both held in place and connected to the circuit 6.

FIG. 19 is an overhead view of an electrode module 5, including the upper holder 10a to which electrodes 51, 52 and struts 35 are connected. The upper member 10w of the holder 10a is omitted for clarity. Sliding interfaces 10s include cooperating rail and bracket-arms. Snap-fit interfaces 10i include a resilient hook arm the end of which locates within a hook-pit.

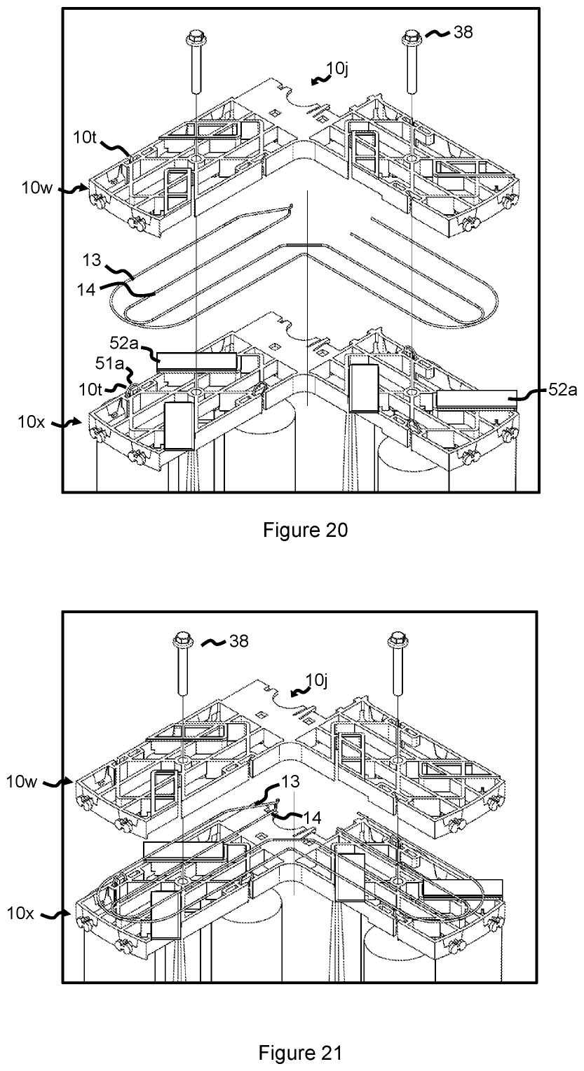

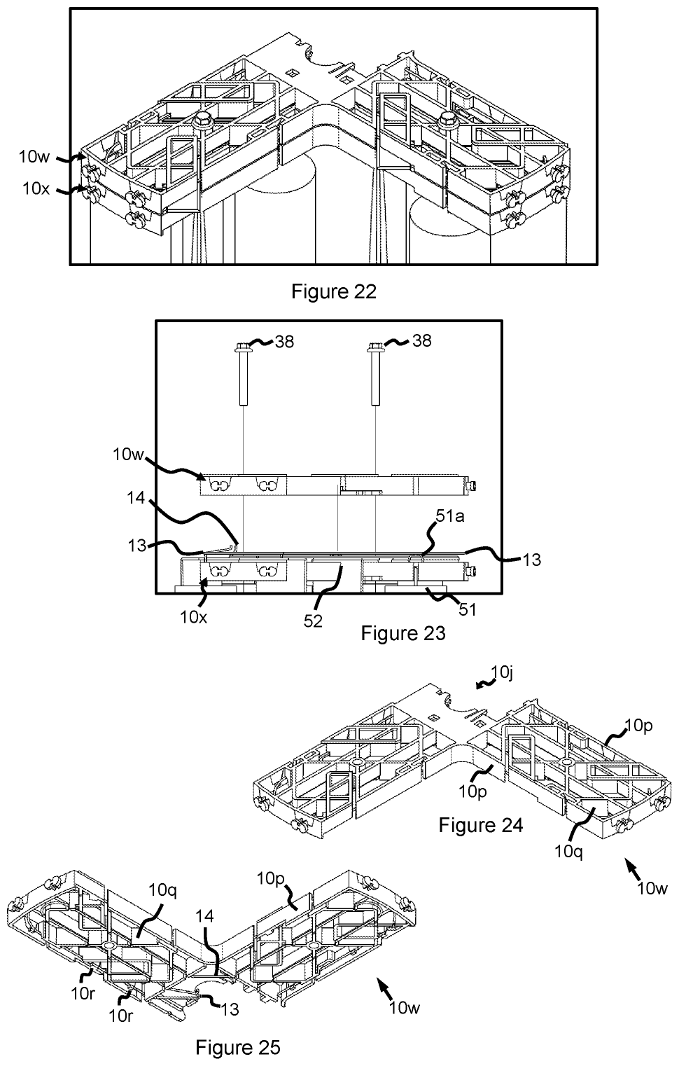

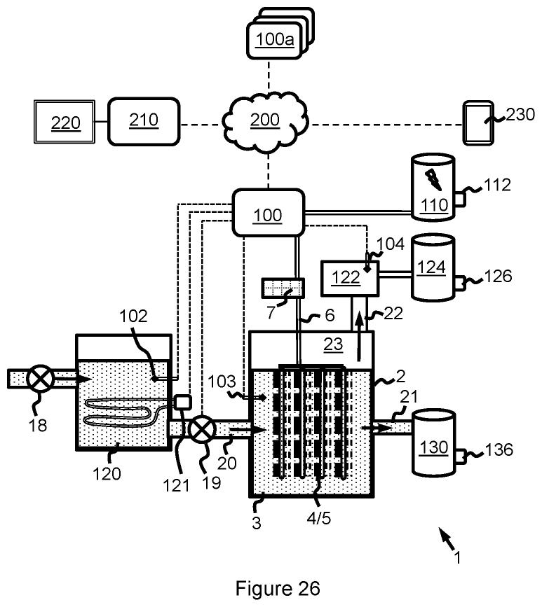

FIGS. 20, 21 and 22 are partial perspective views of the upper end of the electrode module 5 of FIG. 19, showing the progressive combination of the components to allow physical and electrical connection of the electrodes 51, 52. FIG. 23 is a partial side view of the arrangement of components shown in FIG. 21.

FIG. 24 is a perspective overhead view, and FIG. 25 is perspective underside view of a member 10w of the upper holder 10a, with conductors 13, 14 fitted into their respective tracks. The tracks are defined by notches in webs 10q that criss-cross between the peripheral wall 10p of the holder member 10w. The track accommodating the upper outer conductor 13 is also bounded by protrusions 10r that hook under the anodic conductor 13, preventing it from falling out of the track once it has been placed with the track. This keeps the anodic conductor 13 elevated and away from the contact with the ends 52a of the cathodes 52. The conductors 13, 14 are sufficiently elastic such that they snap back into shape. This allows the anodic conductor 13 to be snap-fitted into its respective track by deflecting it past the protrusions 10r.

With reference to FIGS. 19 to 25, conductor tracks are defined within the upper holder 10a to accommodate the conductors 13, 14. The anodic conductor 13 follows an outside and upper track that passes via the wire loop 51a of each anode 51, with the anodic conductor 13 being compressed, during assembly, into each wire loop 51a thereby ensuring reliable electrical contact between each of the anodes 51 and the anodic conductor 13. The cathodic conductor 14 follows an inside and lower track that passes via the crimped ends 52a of the cathodes 52. Although the upper anodic conductor 13 passes over the top of the crimped ends 52a of each cathode 52, it is vertically separated so that it does not make contact. Tightening the bolt 38 clamps the first and second members 10w, 10x of the upper holder 10a together and compresses the cathodic conductor against the flat surface of the crimped end 52a of the cathode 52—again ensuring reliable electrical contact.

The conductors 13, 14 lead to a central junction region 10j, an end of each conductor turning upwards to effectively define a prong to which sockets of a central junction box 56 (as shown in FIG. 14) can be connected, which in turn leads to the circuit 6 as described above.

Each of the upper, middle and lower holders 10a, 10b, 10c have spaced slots defined in them to accommodate spaced connection of the electrodes 51, 52. Thus, each holder defines a plurality of spaced connection regions, each for detachably holding a respective electrode.

Insertion of an electrode 51, 52 into place involving lateral sliding movement of a vertically-oriented electrode relative to the vertically-oriented frame defined by the struts 35 and holders 10a, 10b, 10c. Accordingly, such lateral movement is along a plane normal to the longitudinal axis of each electrode 51, 52. To allow this, each of the slots lead laterally-inward from the peripheral wall 10, and are bounded by webs 10q. Additionally, the slots for the wire loop ends 51a of the anode 51 each lead to a T-shaped recess 10t bisected by a central lateral divider. In the case of the upper holder 10, the divider of the inner (lower) member 10x acts as a seat for supporting the underside of the loop 51a, the upper half of which protrudes upwards for contact with the conductor 13. When the outer (upper) member 10w is lowered over the inner member 10x for clamping, the T-shaped recess underneath the member 10w forms a hood over that upper half of the wire loop 51a, and so encapsulates it, preventing removal.

Nonetheless, when the members 10w, 10x are separated, the slots allow the electrodes 51, 52 to be easily slid onto and off the holders 10, facilitating quick assembly of each electrode module 5, and conversely allows quick disassembly or substitution of electrodes—for example for maintenance purposes.

Advantageously, the cathodes 52 are connected to the upper and lower holders 10a, 10c with the crimped ends 52a of adjacent cathodes being oriented orthogonally to one another. This strengthens the resulting structure, making it less liable to twist or pivot at the junctions between the electrodes and the holders.

Referring back to FIG. 14 the electrode assembly 4 also comprises an outer shell 30, composed of a plurality of resilient fibre-glass rods 31 that are helically wound around an interior volume containing the cluster of electrodes 51, 52. The rods 31 terminate at either end at connector eyelets 32 which snap fit on to lugs 11 defined at the periphery of the upper and lower holders 10a, 10c. When interconnected, the lugs 11 and eyelets 32 are able to rotate relative to one another. The middle holder 10b defines channels 12 through which the rods are routed and so retained to the middle holder 10c. The rods 31 are flexed to wind them around the holders 10c, and this introduces elastic tension in the rods 31 keeping them tautly in place against the holders, and ensuring that the resulting shell 30 defined by the rods is resilient. The shell 30 thus acts as a barrier between the electrodes 51, 52 and structures such as other electrodes that may cause short-circuiting.

Accordingly, the shell 30 advantageously allows different sets of similar electrode assemblies to be introduced into tanks of varying sizes, shapes and configurations without the need to rigidly fix into place each one of those electrode assemblies. This increases the flexibility and modularity of the system.

Although the shell 30 protects the electrode assembly against contact with others, it is a predominantly open structure, thereby allowing waste 3 to flow freely past and throughout the electrodes 51, 52.

This and the other electrode assemblies 4 described here can be used in a variety of wastewater treatment systems, a further extended example of which will now be described.

FIG. 26 is a schematic plan diagram of a wastewater treatment system 1 the components of which are extensions to various embodiments of the present invention.

The system 1 has features in common with those discussed above—namely, the wastewater treatment tank 2 within which wastewater or organic waste 3 is contained for treatment, the electrode assembly 4 having a plurality of electrode modules 5, and the circuit 6 connecting them to the external electrical device 7. However, additional components allow certain benefits and functions to be realised for certain use-cases.

For example, the system 1 can function as a portable electro-methanogenic reactor (EMR) for waste treatment, the recovery of bioenergy, the extraction of nutrients (e.g., Nitrogen (N), Phosphorous (P), and Potassium (K)) and water recovery. This system 1 outputs useful electricity, biogas, and fluid products.

To this end, the system further comprises a pre-treatment tank 120 configured to perform pre-treatment of wastewater or organic waste. This is prior to the introduction of the wastewater 3 into the wastewater treatment tank 2 that contains the electrode modules 5. A first pump 19 controls the flow rate from the pre-treatment tank 120, via the intake 20 to the wastewater tank 2, and likewise a second pump 18 controls flow from an external feedstock source into the pre-treatment tank 120.

It should be noted that in certain embodiments, the pre-treatment tank may also contain electrodes.

This is typically under different operational conditions to the main reactor tank 2, and for the purpose of developing different microbial communities that are optimised to breakdown the waste to a certain point, prior to introduction into the main tank 2.

Other actuators, such as additional pumps and valves, may also be provided. In particular, in the present embodiment, the system 1 comprises a pre-treatment actuator 121 in the form of a heater which is configured to heat the contents of the tank 120 to within a predetermined temperature range. In alternatives, and depending on use-case, the pre-treatment actuator 121 may instead, or in addition, comprise a mechanical breakdown actuator (e.g., a macerator).

The pre-treatment process depends on the feedstock composition and would aim to modify its structure and properties to improve biomass availability to enzymes and microbes. There are different methods involving physical, thermal at high temperatures 50-80, chemical, or biological, i.e., fungal or fermentative. These are chosen depending on the feedstock and use-case. For example, faecal sludge pre-treatment benefits from operating a heater 121 to achieve thermophilic temperature ranges—killing pathogens within the pre-treatment tank 120. Pre-treatment of faecal sludge can also accelerate the hydrolysis stage of the waste degradation which causes a drop in the pH, before entering the main reactor where the waste can be further broken down through the various steps to reach methane production.

Mechanical breakdown of solid waste, via the use of a macerator or similar, can be used to accelerate the microbial decomposition of the organic compounds, following pumping from the pre-treatment tank 120 to the main tank 2 containing the electrode modules 5. The mechanical breakdown of waste aids interaction with the electrode surface area. Contact with the biofilm that is able to breakdown the waste is improved, as is mass transfer interactions between the waste and electrode surface. The mechanical breakdown of waste increases the effectiveness of the internal mixing within the EMR reactor increasing mass transfer on the electrodes. The increased mixing through the initial mechanical breakdown of waste aids in the prevention of biofouling. Specifically, mixing minimises biofilms on the electrodes increasing in thickness above a predetermined threshold (measured in microns) which reduce the energy recovery efficiency. The increased mixing effectiveness allows the optimisation to shear forces to stimulate the removal of dead biofilms on the electrode surface to reduce the need for maintenance and cleaning. In alternatives, biological pre-treatment, for example, fungal or fermentative treatment may be employed.

The system 1 when configured as an EMR, also comprises gas cleaning components. Specifically, the gas port 22 from which gases from the headspace 23 are extracted connects to a gas scrubber 122 configured, in particular, to remove hydrogen sulfide. Carbon dioxide may also be scrubbed. To this end, the gas scrubber 122 may employ catalytic methods and/or otherwise use gas scrubbing media having a high-surface-area to volume ratio, such as GAC (granulated activated carbon), or equivalents (e.g., iron). Silica scrubbing may also be performed by the scrubber 122 to reduce moisture. When scrubbed, the gas can pass to a gas store 124 for storage prior to use.

The system 1 also outputs treated products such as water via the treated water outlet 21. This is typically filtered—for example via multi-stage filtering using GAC (granulated activated carbon), microfilters (0.004 to 0.1 micros)—to remove helminth eggs, pathogens and viruses, and to this end also subjected to pasteurisation, ultraviolet irradiation, chlorination, and/or ozone treatment. The water can then be fed to a product store 130.

Other useful products aside from water may also be outputted (e.g. fertilisers) and these may have their own outlets and stores, but for brevity, only a single outlet 21 and product store 130 is shown.

As an aside, post-treatment of solids settled within the main reactor tank 2—situated in a settling chamber (not shown)—can be circulated into a thermophilic EMR tank operating at temperatures that will pasteurise the waste so that it is safe to discharge into the environment, which could be used as a soil conditioner or fertiliser.

The system 1 also generates electrical energy via the circuit 6 which can pass to a load 7 which in turn can charge an electrical energy store 110.

The system 1 can be optimised for the output of one or more of these products, and/or for generally efficient operation. For example, biogas generation, organic matter removal, or biofilm growth may be optimised. To this end, the system 1 further comprises a controller 100 and a set of sensors 102, 103, 104. By way of schematic example, a first sensor 102 is shown in FIG. 26 as being located in the pre-treatment tank 102, a second sensor 103 in the wastewater tank 2, and a third sensor 104 in the gas scrubber 122. However, it will be appreciated that sensors may be located elsewhere (e.g. between tanks, in the headspace 23, part of each electrode module 5) and that more than one sensor per location may be used.

Furthermore, the sensors themselves may have self-regulating properties, independent of the controller 100. For example, the electrode modules 5 may contain three wires which connect to a modular potentiostat. Two of them apply a set voltage to the anode and cathode and the third is connected to a reference electrode. The reference electrode allows the potentiostat to adjust the applied voltage depending on the biofilm growth on the electrode modules.

Nonetheless, as a general operating principle, the controller 100 receives signals from sensors that indicate properties of the materials handled by the system (e.g. feedstock, wastewater, gas). Properties detected by the sensors, or otherwise inferable by the controller 100 from those properties may include: temperature, liquid turbidity, electrode current density, electrode voltage potential, biogas composition (in particular, percentage of methane, carbon dioxide, hydrogen and hydrogen sulfide), biogas flow rate, pH, alkalinity, quantity of VFA (volatile fatty acids), COD (chemical oxygen demand) and BOD (biochemical oxygen demand).

It should be noted that COD and BOD often require manual laboratory tests to be performed. However, these metrics can be inferred automatically and in real-time by the system 1. Electrode modules are placed within the wastewater treatment tank 2 at different locations with respect to the intake 20 and outlet 21. The sensors allow measurement of electrode current density at two different locations (e.g. one near the intake 20, and the other near the outlet 21). These are used by the controller 100 to determine the difference between electrode current density, and so infer the oxygen demand and so quality of the effluent leaving the outlet 21.

In response to the sensor data, the controller 100 is configured to adjust system processing accordingly (e.g. heating, physical action, fluid flow rates, electrode voltages/currents). For example, the controller 100 is communicatively connected to the pump 19 to control the flow rate into the wastewater tank 2. Similarly, the controller 100 is communicatively connected to the pre-treatment actuator 121 to control the level of heat applied and/or speed of physical treatment. In alternative embodiments, dosing pumps may also be used—for example, to introduce quantities of buffer in response to pH levels. The controller 100 may also comprise a clock for automating schedules, for example scheduling when feedstock is pumped via pump 18 into the pre-treatment tank 120.

Generally, the controller 100 is configured to slow down the rate of flow into each respective tank 120, 2 via pumps 18, 19 in response to detecting a higher COD or VFA content and/or a low pH (i.e. less than pH 6) in the effluent, and vice-versa.

Moreover, the controller 100 is configured to control the applied voltage to the electrode modules in order to control pH. Increasing or decreasing the applied voltage correspondingly increases and decreases hydrogen ion production. This enables the controller 100 to responsively and smartly control pH without the need to add buffering solution.

Additionally, the controller 100 is configured to speed up the rate of flow in response to detecting, over time, that the current density at the electrode modules is declining. This is an indicator that the quantity of organic material within the wastewater 3 is also declining. Accordingly, a higher flow rate can be sustained, which is initiated by the controller 100.

Also, through sensing changes in current density (and thus biofilm growth) the controller 100 can regulate power distribution to electrode modules 5. For this, each module 5 may be connected individually or with localised controllers that allow each module to draw exactly how much power it needs from one shared cable.

Stores at the electricity store 110, gas store 124, and other products stores 130 can therefore be built up, and accessed by consumers via corresponding electricity outlets 112, gas outlets 126, and product outlets 136 respectively.

The features so far described in relation to FIG. 26 relate to components of the system 1 that are typically at a particular wastewater processing site, run by one controller 100. However, other controllers 100a at other sites may be deployed. Accordingly, the system 1 can be tailored for different sites and use-cases. This relates to how each controller 100, 100a is configured to control the hardware at each site, as well as the hardware itself. For example, the treatment of agricultural waste may use larger pipes, and not require as much pre-treatment and post-treatment heating (i.e. pathogen kill is less relevant). For industrial applications, a more intensive wastewater treatment may be appropriate, with filters for filtering out smaller particle sizes allowing smaller pipes to be used. For sanitary waste treatment, a higher pathogen kill configuration is more appropriate (therefore higher temperature heating may be applicable).

Nonetheless, an additional complementary set of features to all of such use-cases—exemplified in FIG. 26—is the additional use of a remote server 210 via which central remote monitoring of each controller 100, 100a—and so of each site—can be performed.

Specifically, each controller 100, 100a, further comprises a communication module allowing the respective controller 100, 100a to exchange data (including all sensor and control data), via network 200 (e.g. the Internet) with the remote server 210. The remote server 210 comprise a user interface 220 allowing monitoring and control staff to monitor the status of each site, and send configuration instructions to each controller 100, 100a to reconfigure it to improve the control of each site. Monitoring in this way allows predictive component usage and so maintenance can be performed at the right time in the right place. This augments the benefits described above relating to the modularity of the electrode modules 5 in particular, allowing better and more timely component collection, replacement and reuse.

Additionally, the server 210 can also connect with end-user devices 230 (e.g. via a mobile app, or a web application) allowing end-user monitoring and control. Specifically, end-users can be displayed key metrics to do with their local BES (e.g. energy generated) and simple alerts to do with day-to-day maintenance. Moreover, end-user devices 230 may be configured to allow customers to purchase resources output by a local BES. In accordance with this, the electricity outlets 112, gas outlets 126, and product outlets 136 can be metered. A user submits a payment and a request to the server 210 for access to a resource at a particular site, and in response to confirming payment, the server 210 instructs the controller 100 at that site to unlock a respective outlet 112, 126, 136 fora predetermined usage period or quantity.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

1. A bio-electrochemical wastewater treatment system comprising:
a wastewater treatment tank, comprising a wastewater intake and a treated water outlet;
an electrode assembly adapted for submersion within the wastewater treatment tank between the intake and outlet, the electrode assembly comprising a set of interconnectable electrode modules, each electrode module having:
a first electrode of an anode-cathode pair coated with electrogenic microbes adapted to generate electrons via the consumption of organic matter in wastewater;
a second electrode of the anode-cathode pair;
a body, supporting and separating the first and second electrodes; and
an interface for physically connecting the module with at least one other of the set, the interface further arranged to electrically-connect the first and second electrodes of the electrode module with respective first and second electrodes of other connected electrode modules of the set; and
a circuit electrically-connecting the electrodes of the set of electrode modules to an external electrical source or load.

2. The system of claim 1, wherein each electrode is elongate, so as to define a longitudinal axis, the first and second electrodes being held by the body so that their respective longitudinal axes are substantially parallel to one another.

3. The system of claim 1, wherein each electrode module further comprises a plurality of holders that define at least in part, the body for supporting and separating the electrodes.

4. The system of claim 3, wherein at least a pair of the holders are spaced from and secured relative to one another by at least one elongate strut to define an elongate framework within which each electrode is held so that a longitudinal axis of the elongate framework, and the longitudinal axes of the electrodes are substantially parallel to one another.

5. The system of claim 3, wherein each holder defines a plurality of spaced connection regions, each for detachably holding a respective electrode.

6. The system of claim 5, wherein the connection regions of each holder comprise a plurality of slots within which an attachment portion of a respective electrode can be encapsulated to prevent relative movement of the electrodes.

7. The system of claim 6, wherein the attachment portion of an electrode is slidable into or out from a respective slot during fitment or removal of that electrode.

8. The system claim 6, wherein the attachment portion of an electrode is electrically-conductive.

9. The system of claim 3, wherein at least one of the plurality of holders comprises a pair of conductor tracks, each retaining a conductor for electrical connection to a respective electrode, a first track running via the first electrode, and a second track running via the second electrode.

10. The system of claim 3, wherein at least one of the holders comprise clamping portions that have a clamping configuration in which the clamping portions are compressed towards one another to trap the electrodes in place.

11. The system of claim 10, wherein the clamping portions, in their clamping configuration, compress a first and second conductor against respective first and second electrodes of multiple modules.

12. The system of claim 9, wherein the holders and conductors in combination define, at least in part, the interface for physically and electrically connecting the electrode module with at least one other of the set.

13. The system of claim 1, wherein the interface of each electrode module comprises a coupling member, such as a plug or socket, for coupling with a complementary coupling member, such as a socket or plug of other electrode modules of the set.

14. The system of claim 13, wherein the body of each electrode module is elongate, with a first end and second end, and the interface of each electrode module comprises first and second complementary coupling members located toward respective first and second ends of the body.

15. The system of claim 1, further comprising a buoy for floating within the wastewater treatment tank, the buoy having a connector configured and arranged for connection with the interface of an electrode module of the set of interconnectable electrode modules thereby, in use, to hang the set of electrode modules from the buoy.

16. The system of claim 15, further comprising a weight (9) having a connector (94) configured and arranged for connection with the interface of an electrode module of the set of interconnectable electrode modules thereby, in use, to draw the electrode assembly into a vertical position between the buoy and the weight.

17. The system of claim 15, wherein the electrode assembly comprises at least two sets of interconnectable electrode modules, and the buoy comprises at least two corresponding connectors for connection with a respective set of electrode modules, the at least two connectors being positioned and spaced from one another onp the buoy to separate each set of electrode modules from one another in use.

18. The system of claim 15, wherein the buoy is inflatable, at least in part.

19. The system of claim 1, wherein the wastewater treatment tank is open at its upper end, and the system further comprising a gas trap configured for attachment relative to the electrode assembly above the electrode modules to capture gas emitted by electrodes of the anode-cathode pair.

20. The system of claim 19, wherein the gas trap and/or buoy supports the external electrical source or load.

21. The system of claim 20, wherein the external electrical source comprises solar panels.

22. The system of claim 1, wherein the electrode assembly comprises a plurality of electrode modules disposed between the intake and the outlet, the spacing between the anode-cathode pairs defined by the electrode modules being at their widest closest to the intake, and narrowest closest to the outlet.

23. The system of claim 1, wherein the electrode assembly is switchable between a unexpanded configuration and an expanded configuration, the electrode modules of the electrode assembly occupying a smaller volume in the unexpanded configuration than in the expanded configuration, and the electrode assembly comprises a support that is inflatable, at least in part, so that when inflated, the electrode assembly is in the expanded configuration, and when deflated, the electrode assembly is in the unexpanded configuration.

24. The system of claim 1, wherein the electrode assembly comprises a shell for isolating the electrode assembly from others, the shell comprising resilient rods that are wound around the electrode modules of the electrode assembly.

25. The system of claim 1, further comprising actuators for controlling at least the flow rate of wastewater into and/or out from the tank 2, and a controller being operatively connected to the actuators in order to control flow rate.

26. The system of claim 25, further comprising sensors communicatively connected to the controller, the controller receiving signals from the sensors that indicate properties of the materials handled by the system and in response adjusts the actuators.

27. The system of claim 25, wherein the controller comprises a communication module for connecting via a network to a remote server, the controller communicating status data to the remote server, and in response receiving configuration data from the server, the configuration data configuring the operation of the controller to control the actuators in response to signals received from the sensors.

28. An electrode assembly adapted for submersion within a wastewater treatment tank for use in a wastewater treatment system, the electrode assembly comprising a set of interconnectable electrode modules, each electrode module having:
a first electrode of an anode-cathode pair coated with electrogenic microbes adapted to generate electrons via the consumption of organic matter in wastewater;
a second electrode of the anode-cathode pair;
a body , supporting and separating the first and second electrodes; and
an interface for physically connecting the module with at least one other of the set, the interface further arranged to electrically-connect the first and second electrodes of the electrode module with respective first and second electrodes of other connected electrode modules of the set.

29. A bio-electrochemical wastewater treatment process comprising:
providing an electrode assembly by interconnecting a set of electrode modules, each electrode module having:
a first electrode of an anode-cathode pair coated with electrogenic microbes adapted to generate electrons via the consumption of organic matter in wastewater;
a second electrode of the anode-cathode pair;
a body, supporting and separating the first and second electrodes; and
an interface for physically connecting the module with at least one other of the set, the interface further arranged to electrically-connect the first and second electrodes of the electrode module with respective first and second electrodes of other connected electrode modules of the set;
submerging the electrode assembly within a wastewater treatment tank, the tank comprising a wastewater intake and a treated water outlet, and the electrode assembly being disposed between the intake and the outlet; and
electrically-connecting the electrodes of the set of electrode modules, via a circuit to an external electrical source or load.
